(19) United States
(12) Patent Application Publication
(10) Pub. No.: US 2018/0268054 A1
(43) Pub. Date: Sep. 20, 2018

(54) SELECTING CONTENT ITEMS FOR PLAYLISTS

(71) Applicant: MICROSOFT TECHNOLOGY LICENSING, LLC, Redmond, WA (US)

(72) Inventors: Julie MUSTAIN, Bellevue, WA (US); Ryan STEFFEN, Issaquah, WA (US); Aaron M. BUTCHER, Redmond, WA (US); Kelly Jean GRAHAM, Seattle, WA (US); Scott D. SANDERS, Sammamish, WA (US); John Thomas KIMBELL, Kirkland, WA (US); Jeffrey Christopher ABRAHAM, Seattle, WA (US); Geeven SINGH, Bellevue, WA (US); Claudio Fernando GUGLIERI LILLO, Redmond, WA (US); Ana Sofia GONZALEZ AGUIRRE, Bellevue, WA (US)

(21) Appl. No.: 15/630,719

(22) Filed: Jun. 22, 2017

Related U.S. Application Data
(60) Provisional application No. 62/473,419, filed on Mar. 19, 2017.

(51) Int. Cl. G06F 17/30; G06F 3/0482

(52) U.S. Cl. CPC G06F 17/30761; G06F 3/0482; G06F 17/30752; G06F 17/30775; G06F 17/30772

(57) ABSTRACT

A playlist engine is provided that selects content items for a partial playlist. The content items may include audio content items (i.e., tracks or songs). In one implementation, a user provides a request to expand a partial playlist. The request may include the partial playlist and an indication of the number of additional content items that the user would like to add to the partial playlist. The playlist engine may select one or more attributes from the content items in the partial playlist, and may use the selected one or more attributes to determine additional content items that are relevant to the selected one or more attributes. The playlist engine may add the additional content items to the partial playlist.

### CLAIM OF PRIORITY

This application claims priority to U.S. Provisional Application No. 62/473,419 filed Mar. 19, 2017, the contents of which are hereby incorporated by reference in their entirety.

### BACKGROUND

Playlists are a popular way to enjoy content items such as music and videos. Typically, a user creates a playlist by selecting content items and adding the content items to the playlist. The playlist can be saved by the user or shared with friends and family.

Playlists are often associated with a particular theme or purpose. For example, a user may generate a playlist for exercising and may include songs with a fast tempo.

While creating playlists can be enjoyable, there are drawbacks associated with creating playlists. One drawback is that it requires the user to have specific knowledge about content items that they are interested in adding to the playlist. For example, a user may want to create a playlist for a party that includes a particular type of rock music that the user enjoys; however, the user may not know the names of any particular songs to add to the playlist.

Another drawback associated with playlists is that creating playlists can be tedious and time consuming. Continuing the example above, the user may be creating a playlist to use for a party that may be anticipated to last four hours. An average song has a length of three and a half minutes, which requires approximately sixty eight songs to fill a four hour playlist. The user may have a few songs in mind to use for the playlist, but may have trouble coming up with sixty eight songs.

Currently, some music services allow users to generate radio stations based on a band or style of music. However, these radio stations are not like playlists in that the user cannot view of the songs that have been selected for the radio station, cannot make changes to any of the songs in the radio station by adding or deleting specific songs, and cannot change the order that the songs are played by the radio station.

### SUMMARY

A playlist engine is provided that selects content items for a partial playlist. The content items may include audio content items (e.g., tracks or songs). In one implementation, a user provides a request to expand a partial playlist. The request may include the partial playlist and an indication of the number of additional content items that the user would like to add to the partial playlist. The playlist engine may select one or more attributes from the content items in the partial playlist, and may use the selected one or more attributes to determine additional content items that are relevant to the selected one or more attributes. The playlist engine may add the additional content items to the partial playlist.

In an implementation, a system for selecting additional content items for playlists based on existing content items and user preferences is provided. The system includes at least one computing device and a playlist engine. The playlist engine may be adapted to: receive a playlist comprising a first plurality of content items; determine attributes associated with the content items of the first plurality of content items; select a second plurality of content items based on the determined attributes; add the second plurality of content items to the received playlist; and provide the playlist.

In an implementation, a system for selecting additional content items for playlists based on existing content items and user preferences is provided. The system includes at least one computing device and a playlist engine. The playlist engine may be adapted to: receive a playlist comprising a first plurality of content items; select attributes associated with the content items of the first plurality of content items; provide the selected attributes; receive a second plurality of content items based on the determined attributes; select a subset of the second plurality of content items; and add the selected subset of the second plurality of content items to the playlist.

In an implementation, a method for selecting additional content items for playlists based on existing content items and user preferences is provided. The method may include: receiving a playlist comprising a first plurality of content items by a computing device; determining attributes associated with the content items of the first plurality of content items by the computing device; selecting a second plurality of content items based on the determined attributes by the computing device; adding the second plurality of content items to the received playlist by the computing device; identifying similar content items in the playlist by the computing device; and removing a subset of the identified similar content items from the playlist by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for extending playlists in response to user requests;

FIG. 2 is an illustration of an implementation of an exemplary playlist engine;

FIGS. 3 and 4 are illustrations of example user interfaces for expanding a partial playlist;

FIG. 5 is an operational flow of an implementation of a method for receiving a partial playlist and for adding content items to the partial playlist based on attributes of the content items in the partial playlist;

FIG. 6 is an operational flow of an implementation of a method for receiving a partial playlist and for adding content items to the partial playlist based on attributes of the content items in the partial playlist;

FIG. 7 is an operational flow of an implementation of a method for receiving a playlist and for removing duplicate content items from the received playlist; and

FIG. 8 shows an exemplary computing environment in which example embodiments and aspects may be implemented.

### DETAILED DESCRIPTION

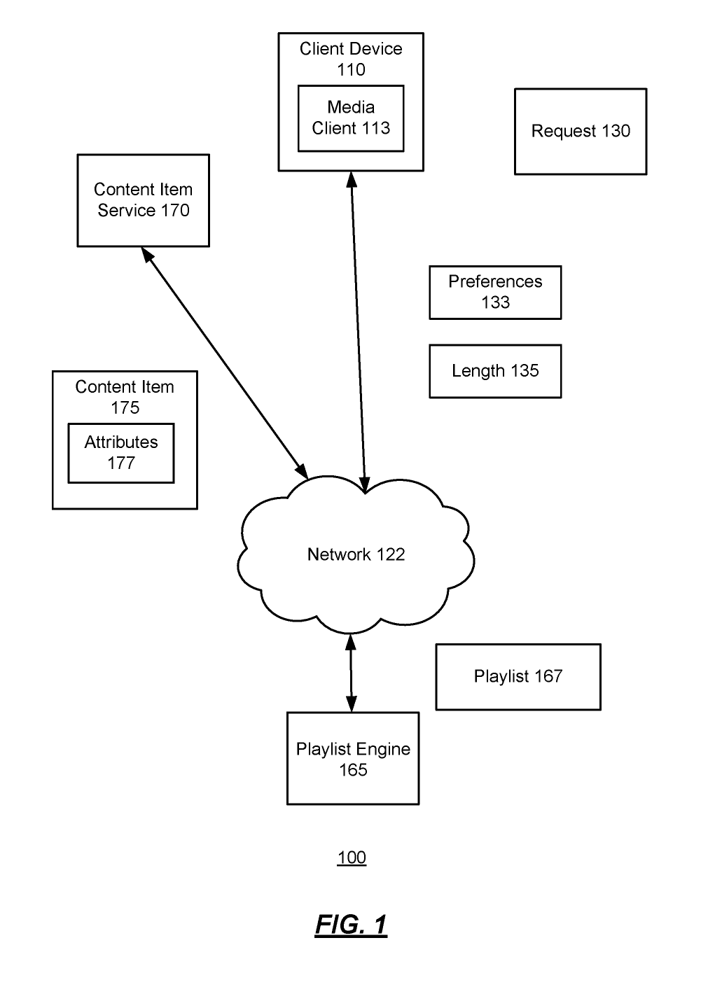

FIG. 1 is an illustration of an exemplary environment 100 for extending playlists in response to user requests. The environment 100 may include a content item service 170, a playlist engine 165, and one or more client devices 110 in communication through a network 122. The network 122 may be a variety of network types including the public switched telephone network (PSTN), a cellular telephone network, and a packet switched network (e.g., the Internet). Although only one client device 110, one playlist engine 165, and one content item service 170 are shown in FIG. 1, there is no limit to the number of client devices 110, playlist engines 165, and content item services 170 that may be supported.

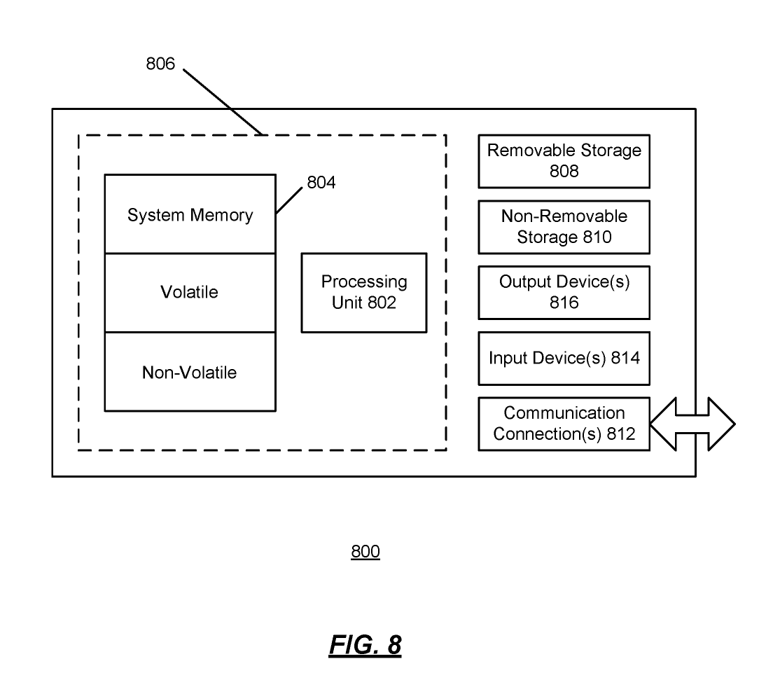

The client device 110, the playlist engine 165, and the content item service 170 may be implemented using a variety of computing devices such as smart phones, desktop computers, laptop computers, tablets, vehicle navigation systems, and video game consoles. Other types of computing devices may be supported. A suitable computing device is illustrated in FIG. 8 as the computing device 800.

Each client device 110 may further include a media client 113. The media client 113 may be used by a user of the client device 110 to view and interact with one or more content items 175. Content items 175 may include audio content items (e.g., music tracks, songs, podcasts, and other audio recordings), and video content items (e.g., television shows, movies, vlogs, and other video recordings). Note that while the media client 113, the playlist engine 165, and the content item service 170 are shown as being distinct entities, in some implementations some or all of the functionality attributed to each entity can be performed by a different entity or any combination of entities. Note that any features or functionality described with respect to audio content items is meant to also apply to video content items, and vice versa.

Each content item 175 may further include one or more attributes 177. The attributes 177 associated with a content item 175 may describe the contents of the content item 175. For audio content items 175, the attributes 177 may include artist, genre, album, title, length, and date, for example. Other types of attributes 177 may describe the sound of the audio content item 175 and may indicate the tempo, the types of instruments used in the audio content item 175, the type of vocalizations used in the audio content item 175, whether or not the audio content item 175 uses electronic or acoustic instruments, the type and/or style of percussion used in the audio content item, and whether or not the audio content item 175 includes changes in speed or tempo, and whether or not the audio content item is dissonant, for example. Any word or phrase that may be used to describe audio or music may be included in the attributes 177. Attributes 177 may also be referred to as “seeds” or “signals.”

For video content items 175, the attributes 177 may include actors, directors, genre, title, length, and date, for example. Other types of attributes 177 may describe the look and sound of the video content item 175 and may include any word or phrase that may be used to describe video or film.

In some implementations, the attributes 177 may be determined by the media client 113 automatically for a content item 175 based on metadata associated with the content item 175. These may include attributes such as artist, title, length, etc. Other attributes 177 may be determined by the media client 113 from analyzing the content item 175. These may include attributes 177 such as tempo and types of instruments used, and other attributes 177 that may describe the style, sound, or look, of the content item 175. Alternatively or additionally, the attributes 177 for a content item 175 may be provided by one or more content item services 170.

The content items 175 used by the media client 113 may be provided by the user of the client device 110. For example, the user may store and maintain a personal collection of content items 175. Alternatively, the content items 175 may be provided by one or more content item services 170. The content item service 170 may be an entity that makes a variety of content items 175 available for download or streaming by a user. The content item service 170 may be free, subscription-based, pay per content item 175, or some combination of the above.

A playlist 167 may be a collection of content items 175, that may be saved by the user, and shared with other users. Typically, each playlist 167 is created around a theme or purpose by the user. For example, a user may create a playlist 167 of upbeat audio content items 175 to listen to while driving to work called “drive to work”, and the user may create a playlist 167 of relaxing audio content items 175 to listen to while driving home from work called “driving home.” In another example, a user may create a playlist 167 that includes video content items 175 for their daughter called “TV for Charlotte.” The user may share the playlist with a babysitter to use while babysitting the user's daughter.

Depending on the implementation, a playlist 167 may include the content items 175. Alternatively, the playlist 167 may include pointers to each content item 175. The pointers may point to the content items 175 in the user's personal collection, or at the content item service 170. A single playlist 167 may combine content items 175 from a variety of content item services 170 and user collections.

As described above, one drawback associated with using playlists 167 is that the user may have to create the entire playlist 167 themselves. Accordingly, rather than have the user create an entire playlist 167 using the media client 113, the playlist engine 165 may extend a partial playlist 167 generated by a user by recommending additional content items 175 that may be added to the partial playlist 167. The playlist engine 165 may recommend content items 175 that are similar or related to the content items 175 that the user already added to the partial playlist 167. Depending on the implementation, the additional content items 175 may be recommended based on one or more attributes 177 of some or all of the content items 175 that were added to the partial playlist 167 by the user.

In order to expand a partial playlist 167, the media client 113 may generate a request 130 that includes the partial playlist 167. Alternatively, the media client 113 may generate a request 130 that includes one or more the attributes 177 of some or all of the content items 175 from the partial playlist 167. Depending on the implementation, the media client 113 may generate the request 130 in response to a user of the media client 113 selecting a button or user interface element.

The playlist engine 165 may receive the request 130 and may provide the attributes 177 of the request 130 to a content item service 170. The playlist engine 165 may provide the attributes 177 to the content item service 170. In some implementations, the content item service 170 may identify content items 175 that have attributes 177 that are similar or related to the attributes 177 of the request 130. Whether an attribute 177 is similar or related to another attribute 177 may be based on the viewing or listening habits of other users, for example.

The content item service 170 may recommend one or more of the identified content items 175, and the playlist engine 165 may add pointers to the recommended content items 175 to the partial playlist 167. The user of the media client 113 may approve or reject the content items 175 that are added to the partial playlist 167.

The content item service 170 may include what is referred to herein as a “multi-seed service”. A multi-seed service is a service that, through analysis of content and user listening and/or viewing behavior, can determine and recommend content items 175 based on attributes 177 included in a request 130. Depending on the implementation, the attributes 177 may be provided to the content item service 170 as “seeds”.

The generated request 130 may further include one or more preferences 133 and a length 135. The length 135 may be the total desired length 135 of the playlist 167 or the number of additional content items 175 requested for the partial playlist 167. Alternatively, the length 135 may be the desired total duration in time for the partial playlist 167 (i.e., five hours).

The preferences 133 may be rules or guidelines that are set by the user for the content items 175 that are added to the partial playlist 167. Example preferences 133 may include length (e.g., songs less than 3 minutes or songs no longer than 7 minutes), profanity (e.g., no songs with foul language or explicit lyrics), and era (e.g., “only songs from the 50s” or “only songs from the last three years”). Other preferences 133 may be supported.

In some implementations, the playlist engine 165 may enforce or apply preferences 133 after content items 175 have been recommended by the content item service 170. For example, the preference(s) 133 associated with a request 130 may be for songs that are greater than five minutes. After the content item service 170 recommends content items 175, the playlist engine 165 may select the recommended content items 175 that are greater than five minutes, and may discard the rest. Alternatively, the playlist engine 165 may provide the preferences 133 to the content item service 170, and the content item service 170 may ensure that the recommended content items 175 confirm to the request 130.

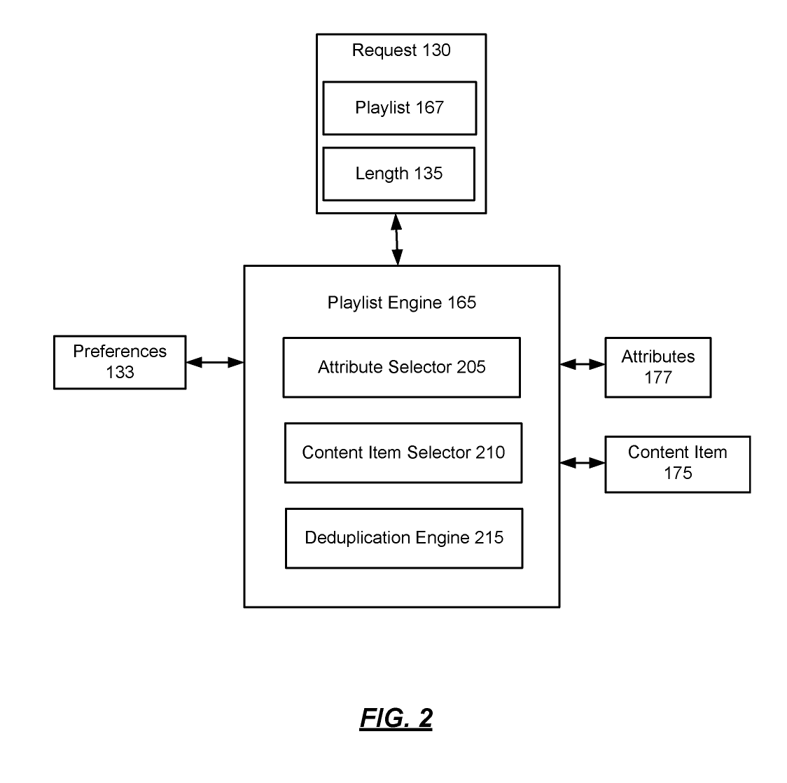

FIG. 2 is an illustration of an implementation of an exemplary playlist engine 165. The playlist engine 165 may include one or more components including an attribute selector 205, a content item selector 210, and a deduplication engine 215. More or fewer components may be included in the playlist engine 165. Some or all of the components of the playlist engine 165 may be implemented by one or more computing devices such as the computing device 800 described with respect to FIG. 8. In addition, some or all of the functionality attributed to the playlist engine 165 may be performed by the media client 113, and vice versa.

The playlist engine 165 may receive a request 130 to expand a partial playlist 167. The request 130 may be to add some number of content items 175 to the playlist 167 indicated by, or included in, the request 130. The number of content items 175 may be specified by the length 135. The length 135 may be included in the request 130.

The attribute selector 205 may select one or more attributes 177 from the content items 175 from the partial playlist 167. In some implementations, the attribute selector 205 may select all of the attributes 177 of the content items 175, or may select some subset of the attributes 177. For example, the attribute selector 205 may randomly select a subset of the attributes 177.

In some implementations, the attribute selector 205 may select attributes 177 that are associated with multiple content items 175 of the partial playlist 167. The attribute selector 205 may select attributes 177 that are associated with a majority or some percentage of the content items 175 of the playlist 167. Conversely, the attribute selector 205 may not select, or may discard, attributes 177 that are associated with less than some percentage of the content items 175. For example, if the partial playlist 167 includes ten content items 175 and nine of the ten content items 175 are associated with the attribute 177 “Rap” and one of the content items 175 is associated with the attribute 177 “Rock”, then the attribute selector 205 may select the attribute 177 “Rap” and may discard the attribute 177 “Rock”.

In some implementations, the attribute selector 205 may select a subset of the content items 175 in the partial playlist 167, and may select the attributes 177 associated with the content items 175 in the selected subset. In one example, the attribute selector 205 may randomly select one or more content items 175.

In another example, the attribute selector 205 may select content items 175 based on their positions in the partial playlist 167. For example, the attribute selector 205 may select a first content item 175 in the partial playlist 167 and/or a last content item 175 in the partial playlist 167. The attribute selector 205 may randomly select content items 175 until a desired number of content items 175 have been selected. Other methods for selecting content items 175 may be used.

The attribute selector 205 may select the attributes 177 from the selected content items 175. The attribute selector 205 may use the selected attributes 177 to request content items 175 from the content item service 170. Depending on the implementation, each selected attribute 177 may be submitted to the content item service 170 as a seed. In response to each submitted attributes 177, the content item service 170 may return a plurality of content items 175 (or indicators of content items 175) that match or include the attribute 177.

Alternatively, rather than provide the attributes 177 to the content item service 170, the attribute selector 205 may provide the selected content items 175 (or indicators of the selected content items 175) from the partial playlist 167 to the content item service 170. The content item service 170 may determine the attributes 177 (i.e., seeds) from the selected content items 175 and may return matching content items 175 (or indicators of content items 175).

The content item selector 210 may select content items 175 for the partial playlist 167. The content item selector 210 may select the content items 175 from the content items 175 returned by the content item service 170. The number of content items 175 that are selected may depend on the number of content items 175 requested (i.e., based on the length 135). For example, if the length 135 indicates that five content items 175 were requested for the playlist 175, then the content item selector 210 may select five content items 175. In another example, if the length 135 indicates that one hour of content items 175 are requested, then the content item selector 210 may select content items 175 having a total duration of around one hour.

The content item selector 210 may randomly select content items 175 from the content items 175 returned by the content item service 170. As may be appreciated, the content item service 170 may return a set of content items 175 for each attribute 177 or seed that that was selected by the attribute selector 205. Accordingly, the content item selector 210 may select the content items 175 by randomly selecting a content item 175 from each set of content items 175 until the desired number of content items 175 are selected, or the desired duration is reached.

Alternatively, the content item selector 210 may weight each content item 175 based on the number of sets of content items 175 that the content item 175 was returned in, and may select the content items 175 according to the weights. For example, a first content item 175 may be returned by the content item service 170 in response to multiple attributes 177, while a second content item 175 may be returned by the content item service 170 in response to a single attribute 177. Intuitively, the first content item 175 should be selected for the partial playlist 167 over the second content item 175. Other methods for selecting content items 175 may be used.

The content item selector 210 may further select content items 175 based on one or more preferences 133. As may be appreciated, the preferences 133 may include guidelines or other criteria that were provided by a user such as limits on the length of each content item 175, and whether or not the content items 175 may include profanity, for example. Accordingly, the content item selector 210 may further select content items 175 that conform to the one or more preferences 133. Depending on the implementation, the one or more preferences 133 may have been included in the request 130, or may be stored in a file or other location and associated with the user that generated the request 130.

In some implementations, the preferences 133 may include signals, ratings, or other indicators of which content items 175 that the user is likely to enjoy. For example, the preferences 133 may indicate which content items 175 the user has enjoyed in the past and/or which content items 175 the user has not enjoyed in the past.

In order to select content items 175 based on the preferences 133, the content item selector 210 may rank the content items 175 returned by the content item service 170 based on the preferences 133. The content item selector 210 may select the content items 175 for the partial playlist 167 according to the ranking.

As may be appreciated, the preferences 133 may be personal and private. Accordingly, to protect the privacy of the user, some or all of the preferences 133 may be encrypted. Moreover, before any data associated with a user is collected and/or used by the media client 113 and/or the playlist engine 165, the user may be asked to opt-in or otherwise consent to the use and/or collection of such data.

The content item selector 210 may add the selected content items 175 (or identifiers of the content items 175) to the playlist 167, and may return the playlist 167 to the user or client device 110 that provided the request 130. Alternatively, the content item selector 210 may provide the selected content items 175 (or identifiers of the content items 175) to the user or client device 110 that provided the request 130. The user or client device 110 may add the selected content items 175 to the partial playlist 167, or may reject some or all of the selected content items 175.

The deduplication engine 215 may remove duplicate, or near-duplicate, content items 175 from a playlist 167 (or partial playlist 167). For example, because of remastered album versions, greatest hits albums, box sets, etc., there may be many versions of a content item 175. For example, certain Beatles songs may exist in an original mono version, a stereo version, and a remastered version. In another example, a song may have a radio edit, and a longer album edit. While not identical, these songs may be too similar to include on the same playlist 167. Similar issues may exist with respect to video content items 175. For example, a film may have a letter box version, a DVD version, a director's cut, and an extended version. A television show may have a high definition version and a standard definition version.

Accordingly, to avoid repetition in the playlist 167, the deduplication engine 215 may remove duplicate or similar content items 175 from the playlist 167. Depending on the implementation, the playlist engine 165 may identify similar content items 175 using a database of known duplicate or similar content items 175. Alternatively, or additionally, the playlist engine 165 may analyze the contents of the content items 175 to identify similar content items 175.

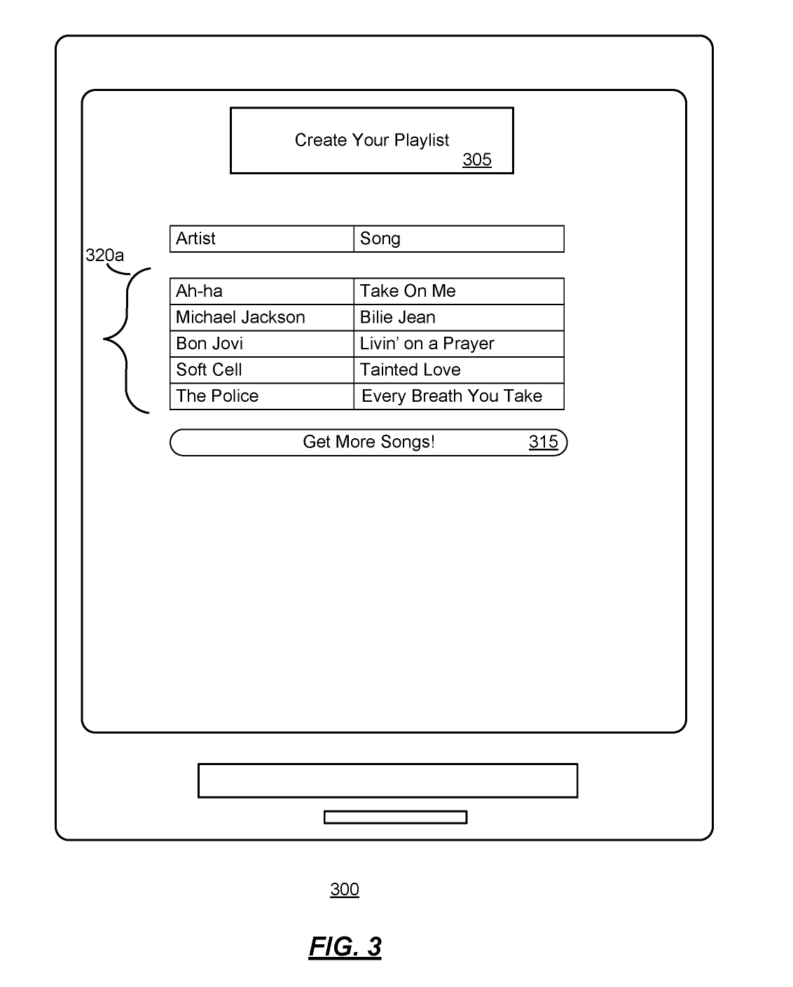

FIG. 3 is an illustration of an example user interface 300 for expanding a partial playlist 167. The user interface 300 may be part of the media client 113, and may be displayed to a user on a client device 110. In the example shown, the client device 110 is a tablet computer. Other types of computing devices may be supported.

The user interface 300 includes a text box 305 asking the user to “Create Your Playlist.” Accordingly, the user has created a playlist 167 that includes five content items 175 which are shown in the user interface 300 as the content items 320a. Depending on the implementation, the user may have selected each of the content items 320a for the playlist 167.

In the example shown, each of the content items 320a is associated with the displayed attributes 177 of “Artist” and “Song.” Other attributes 177 may be supported.

The user interface 300 further includes a user interface element 315 labeled “Get More Songs!” The user may select or actuate the user interface element 315 using a touch interface provided by the client device 110. Other types of interfaces may be supported.

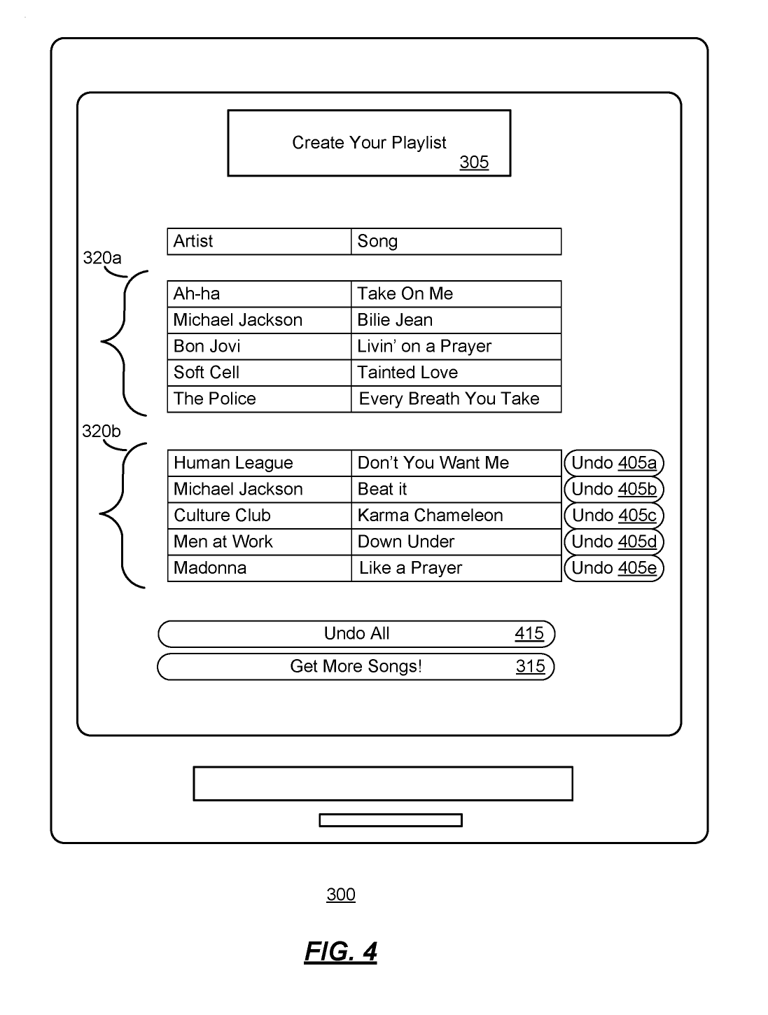

Continuing to FIG. 4, after the user selects the user interface element 315, some or all of the attributes 177 of the content items 320a were used to recommend additional content items 175 for the playlist 167. These content items 175 are shown in the user interface 300 as the content items 320b. In the example shown, five content items 320b have been recommended.

In addition, adjacent to each content item 320b is displayed a user interface element 405 (i.e., the user interface elements 405a-e) labeled “Undo”. The user may select a user interface element 405 to reject the corresponding content item 320b. Depending on the implementation, when the user rejects a content item 320b, it may be removed from the user interface 300, and a substitute content item 320b may be added in its place. The user interface 300 also includes a user interface element 415 labeled “Undo All” through which the user may reject all of the recommended content items 320b.

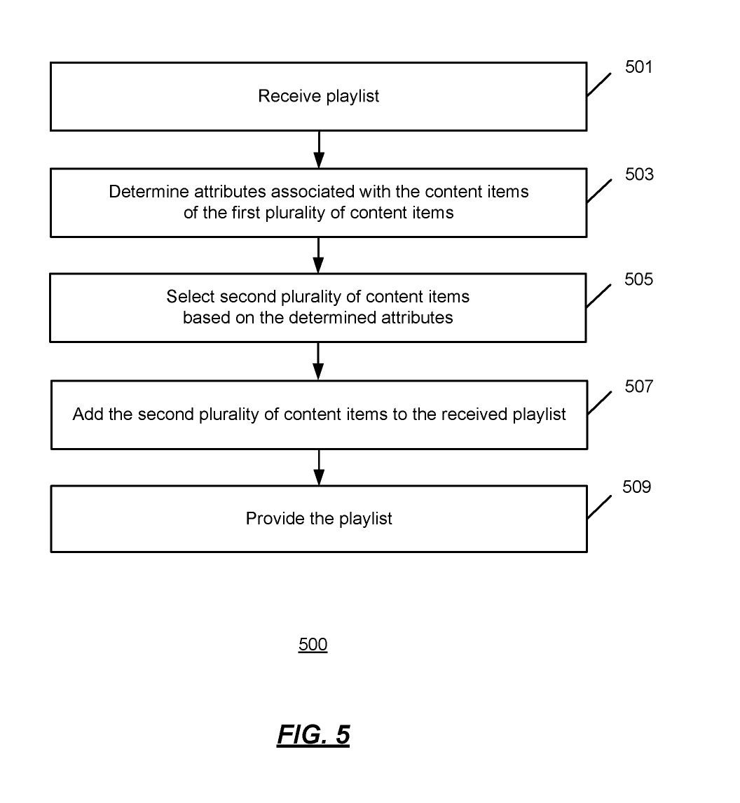

FIG. 5 is an operational flow of an implementation of a method 500 for receiving a partial playlist and for adding content items to the partial playlist based on attributes of the content items in the partial playlist. The method 500 may be implemented by the playlist engine 165 and/or the media client 113.

At 501, a playlist is received. The playlist 167 may be received by the playlist engine 165 from a user of the media client 113. The playlist 167 may be a partial playlist 167 and may be received as part of a request 130. The partial playlist 167 may include a first plurality of content items 175. The request 130 may be for the playlist engine 165 to “complete” the playlist by adding a second plurality of content items 175. Depending on the implementation, the request 130 may include a length 135 and one or more preferences 133.

At 503, attributes associated with the content items of the first plurality of content items are determined. The attributes 177 may be determined by the attribute selector 205 of the playlist engine 165. The attributes 177 may be determined by the attribute selector 205 from metadata associated with each content item 175 in the first plurality of content items 175. Alternatively, the attribute selector 205 may get the attributes 177 for each content item 175 from a database of attributes 177. In other implementations, the playlist engine 165 and/or the content item service 170 may determine the attributes 177 by analyzing or processing the content items 175 to determine characteristics and properties of each content item 175.

In some implementations, the attribute selector 205 may determine attributes 177 for all of the content items 175 in the partial playlist 167. Alternatively, the attribute selector 205 may determine attributes 177 for a subset of the content items 175 in the partial playlist 167. For example, the attribute selector 205 may determine attributes for a first content item 175 in the partial playlist 167 and/or a last content item 175 in the partial playlist 167.

At 505, a second plurality of content items are selected based on the determined attributes. The second plurality of content items 175 may be selected by the content item service 170 using the attributes 177 associated with the content items 175 in the first plurality of content items 175.

Depending on the implementation, some or all of the determined attributes 177 may be provided to the content item service 170 as seeds. The content item service 170 may select content items 175 that match some or all of the provided seeds.

At 507, the second plurality of content items are added to the received playlist. The second plurality of content items 175 may be added to the received partial playlist 167 by the content item selector 210 of the playlist engine 165.

In some implementations, the content item selector 210 may add a subset of the second plurality of content items 175 to the partial playlist 167. For example, the content item selector 210 may randomly add content items 175 from the second plurality of content items 175 to the partial playlist 167, or may add content items 175 to the partial playlist 167 based on preferences 133. The number of content items 175 from the second plurality of content items 175 that are added to the partial playlist 167 may be dependent on the length 135 included in the request 130, for example.

At 509, the playlist is provided. The expanded playlist 167 may be provided to the user of the client device 110 that provided the partial playlist 167 by the playlist engine 165. Depending on the implementation, the deduplication engine 215 of the playlist engine 165 may identify and remove similar content items 165 from the expanded playlist 167 before providing the playlist 167.

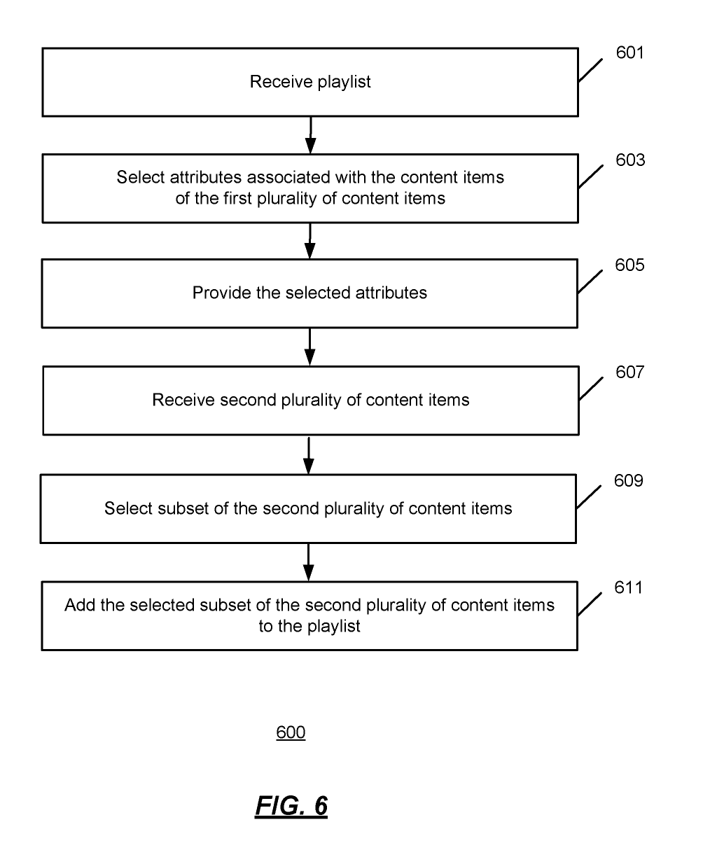

FIG. 6 is an operational flow of an implementation of a method 600 for receiving a partial playlist and for adding content items to the partial playlist based on attributes of the content items in the partial playlist. The method 600 may be implemented by the playlist engine 165 and/or the media client 113.

At 601, a playlist is received. The playlist 167 may be received by the playlist engine 165 from a user of the media client 113. The playlist 167 may be a partial playlist 167 and may be received as part of a request 130. The partial playlist 167 may include a first plurality of content items 175. The request 130 may be for the playlist engine 165 to “complete” the playlist by adding a second plurality of content items 175. Depending on the implementation, the request 130 may include a length 135 and one or more preferences 133.

At 603, attributes associated with the content items of the first plurality of content items are selected. The attributes 177 may be selected by the attribute selector 205 of the playlist engine 165. In some implementations, the attribute selector 205 may select attributes 177 from all of the content items 175 in the partial playlist 167. Alternatively, the attribute selector 205 may select attributes 177 from a subset of the content items 175 in the partial playlist 167.

At 605, the selected attributes are provided. The selected attributes 177 may be provided by the attribute selector 205 of the playlist engine 165 to one or more content item services 170. The content item services 170 may be multi-seed services.

At 607, a second plurality of content items 175 is received. The second plurality of content items 175 may be received by the content item selector 210 of the playlist engine 165 from one or more of the content item services 170. Each content item 175 may have been provided in response to one or more of the provided attributes 177.

At 609, a subset of the second plurality of content items 175 is selected. The subset of the second plurality of content items 175 may be selected by the content item selector 210 of the playlist engine 165. Depending on the implementation, the subset may be selected by the content item selector 210 based on the preferences 133 and/or the length 135.

At 611, the selected subset of the second plurality of content items is added to the playlist. The selected subset of the second plurality of content items 175 may be added to the playlist 167 by the content item selector 210 of the playlist engine 165. The completed playlist 167 may be provided to the user or client device 110 in response to the request 130.

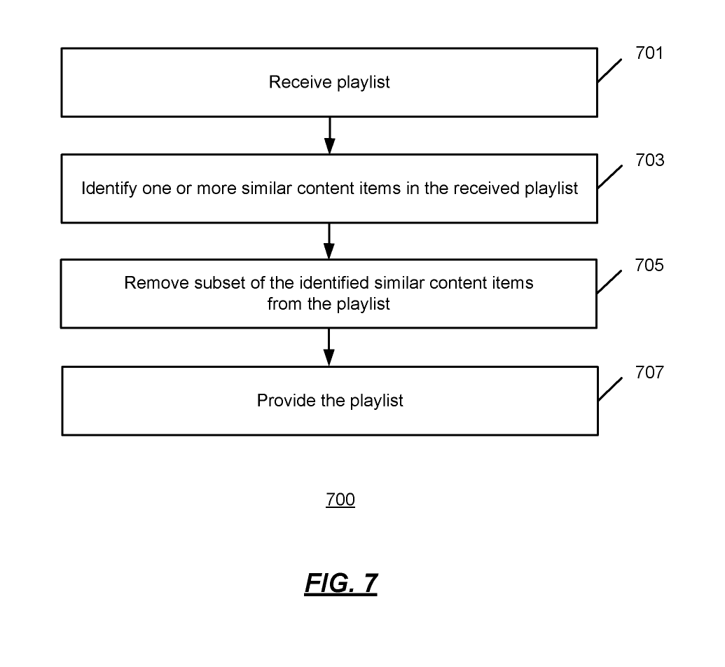

FIG. 7 is an operational flow of an implementation of a method 700 for receiving a playlist and for removing duplicate content items from the received playlist. The method 700 may be implemented by the playlist engine 165 and/or the media client 113.

At 701, a playlist is received. The playlist 167 may be received by the deduplication engine 215 of the playlist engine 165. The playlist 167 may include a plurality of content items 175. Depending on the implementation, the playlist 167 may have been received by the content item selector 210. The content item selector 210 may have completed the playlist 167 by adding one or more content items 175 to the playlist 167.

At 703, one or more similar content items in the received playlist are identified. The similar content items 175 may be identified by the deduplication engine 215 of the playlist engine 165. The similar content items 175 may include duplicate and near-duplicate content items 175. Depending on the implementation, the deduplication engine 215 may identify similar content items 175 using a database or list of known similar content items 175. Alternatively, or additionally, the deduplication engine 215 may identify similar content items 175 by analyzing or processing each content item 175.

At 705, a subset of the identified similar content items is removed from the playlist. The subset of the identified similar content items 175 may be removed from the playlist 167 by the deduplication engine 210 of the playlist engine 165.

At 707, the playlist is provided. The playlist 167 may be provided to a user of a client device 110 that is associated with the playlist 167 by the deduplication engine 215 of the playlist engine 165.

FIG. 8 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 800. In its most basic configuration, computing device 800 typically includes at least one processing unit 802 and memory 804. Depending on the exact configuration and type of computing device, memory 804 may be volatile (such as random access memory (RAM)), non-volatile (such as read-only memory (ROM), flash memory, etc.), or some combination of the two. This most basic configuration is illustrated in FIG. 8 by dashed line 806.

Computing device 800 may have additional features/functionality. For example, computing device 800 may include additional storage (removable and/or non-removable) including, but not limited to, magnetic or optical disks or tape. Such additional storage is illustrated in FIG. 8 by removable storage 808 and non-removable storage 810.

Computing device 800 typically includes a variety of computer readable media. Computer readable media can be any available media that can be accessed by the device 800 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 804, removable storage 808, and non-removable storage 810 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of computing device 800.

Computing device 800 may contain communication connection(s) 812 that allow the device to communicate with other devices. Computing device 800 may also have input device(s) 814 such as a keyboard, mouse, pen, voice input device, touch input device, etc. Output device(s) 816 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for selecting additional content items for playlists based on existing content items and user preferences is provided. The system includes at least one computing device and a playlist engine. The playlist engine may be adapted to: receive a playlist comprising a first plurality of content items; determine attributes associated with the content items of the first plurality of content items; select a second plurality of content items based on the determined attributes; add the second plurality of content items to the received playlist; and provide the playlist.

Implementations may include some or all of the following features. The playlist engine may be further adapted to receive a length, and the playlist engine adapted to select the second plurality of content items may include the playlist engine adapted to select a number of content items for the second plurality of content items based on the length. The one or more attributes may include one or more of genre, artist, album, tempo, and style. The playlist engine may be further adapted to receive one or more preferences, select a subset of the selected second plurality of content items based on the one or more preferences, and add the selected subset of the selected second plurality of content items to the received playlist. The one or more preferences may include length preferences and date preferences. The content items may include audio content items and video content items. The playlist engine may be further adapted to identify similar content items in the playlist, and to remove a subset of the identified similar content items from the playlist. The playlist engine adapted to select the second plurality of content items based on the determined one or more attributes may include the playlist engine adapted to select the second plurality of content items using a multi-seed service.

In an implementation, a system for selecting additional content items for playlists based on existing content items and user preferences is provided. The system includes at least one computing device and a playlist engine. The playlist engine may be adapted to: receive a playlist comprising a first plurality of content items; select attributes associated with the content items of the first plurality of content items; provide the selected attributes; receive a second plurality of content items based on the determined attributes; select a subset of the second plurality of content items; and add the selected subset of the second plurality of content items to the playlist.

Implementations may include some or all of the following features. The playlist engine may be further adapted to receive a length, and the playlist engine adapted to select the subset of the second plurality of content items may include the playlist engine adapted to select a number of content items for the subset based on the length. The one or more attributes comprises one or more of genre, artist, album, tempo, and style. The playlist engine may be further adapted to receive one or more preferences, and select the subset of the selected second plurality of content items based on the received one or more preferences. The one or more preferences may include length preferences and date preferences. The content items may include audio content items and video content items. The playlist engine may be further adapted to identify similar content items in the playlist, and to remove one or more of the identified similar content items from the playlist. The playlist engine adapted to provide the selected attributes may include the playlist engine adapted to provide the selected attributes to a multi-seed service.

In an implementation, a method for selecting additional content items for playlists based on existing content items and user preferences is provided. The method may include: receiving a playlist comprising a first plurality of content items by a computing device; determining attributes associated with the content items of the first plurality of content items by the computing device; selecting a second plurality of content items based on the determined attributes by the computing device; adding the second plurality of content items to the received playlist by the computing device; identifying similar content items in the playlist by the computing device; and removing a subset of the identified similar content items from the playlist by the computing device.

Implementations may include some or all of the following features. The method may further include receiving a length, and selecting a number of content items for the second plurality of content items based on the length. The one or more attributes may include one or more of genre, artist, track, album, tempo, and style. The method may further include selecting the second plurality of content items using a multi-seed service.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for selecting additional content items for playlists based on existing content items and user preferences, the system comprising:
at least one computing device; and
a playlist engine adapted to:
receive a playlist comprising a first plurality of content items;
determine attributes associated with the content items of the first plurality of content items;
select a second plurality of content items based on the determined attributes;
add the second plurality of content items to the received playlist; and
provide the playlist.

2. The system of claim 1, wherein the playlist engine is further adapted to receive a length, and the playlist engine adapted to select the second plurality of content items comprises the playlist engine adapted to select a number of content items for the second plurality of content items based on the length.

3. The system of claim 1, wherein the one or more attributes comprises one or more of genre, artist, album, tempo, and style.

4. The system of claim 1, wherein the playlist engine is further adapted to receive one or more preferences, select a subset of the selected second plurality of content items based on the one or more preferences, and add the selected subset of the selected second plurality of content items to the received playlist.

5. The system of claim 4, wherein the one or more preferences comprise length preferences and date preferences.

6. The system of claim 1, wherein the content items comprise audio content items and video content items.

7. The system of claim 1, wherein the playlist engine is further adapted to identify similar content items in the playlist, and to remove a subset of the identified similar content items from the playlist.

8. The system of claim 1, wherein the playlist engine adapted to select the second plurality of content items based on the determined one or more attributes comprises the playlist engine adapted to select the second plurality of content items using a multi-seed service.

9. A system for selecting additional content items for playlists based on existing content items and user preferences, the system comprising:
at least one computing device; and
a playlist engine adapted to:
receive a playlist comprising a first plurality of content items;
select attributes associated with the content items of the first plurality of content items;
provide the selected attributes;
receive a second plurality of content items based on the determined attributes;
select a subset of the second plurality of content items; and
add the selected subset of the second plurality of content items to the playlist.

10. The system of claim 9, wherein the playlist engine is further adapted to receive a length, and the playlist engine adapted to select the subset of the second plurality of content items comprises the playlist engine adapted to select a number of content items for the subset based on the length.

11. The system of claim 9, wherein the one or more attributes comprises one or more of genre, artist, album, tempo, and style.

12. The system of claim 9, wherein the playlist engine is further adapted to receive one or more preferences, and select the subset of the selected second plurality of content items based on the received one or more preferences.

13. The system of claim 12, wherein the one or more preferences comprise length preferences and date preferences.

14. The system of claim 9, wherein the content items comprise audio content items and video content items.

15. The system of claim 9, wherein the playlist engine is further adapted to identify similar content items in the playlist, and to remove one or more of the identified similar content items from the playlist.

16. The system of claim 9, wherein the playlist engine adapted to provide the selected attributes comprises the playlist engine adapted to provide the selected attributes to a multi-seed service.

17. A method for selecting additional content items for playlists based on existing content items and user preferences, the method comprising:
receiving a playlist comprising a first plurality of content items by a computing device;
determining attributes associated with the content items of the first plurality of content items by the computing device;
selecting a second plurality of content items based on the determined attributes by the computing device;
adding the second plurality of content items to the received playlist by the computing device;
identifying similar content items in the playlist by the computing device; and
removing a subset of the identified similar content items from the playlist by the computing device.

18. The method of claim 17, further comprising receiving a length, and selecting a number of content items for the second plurality of content items based on the length.

19. The method of claim 17, wherein the one or more attributes comprises one or more of genre, artist, track, album, tempo, and style.

20. The method of claim 17, further comprising selecting the second plurality of content items using a multi-seed service.
